(19) United States
(12) Patent Application Publication
(10) Pub. No.: US 2007/0138867 A1
(43) Pub. Date: Jun. 21, 2007

(54) Apparatus for adjusting phase between the different phases in power line communication system

(75) Inventors: Jun-hae Choi, Seongnam-si (KR); In-hwan Kim, Suwon-si (KR); Seung-gi Chang, Seoul (KR); Joon-hee Lee, Gunpo-si (KR); Ju-han Lee, Suwon-si (KR); Ji-hoon Kim, Hwaseong-si (KR); Ho-jeong You, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/582,960

(22) Filed: Oct. 19, 2006

(30) Foreign Application Priority Data
Dec. 19, 2005 (KR) 10-2005-0125451

(51) Int. Cl. H02J 3/02; G05B 11/01; G08B 1/08

(52) U.S. Cl. 307/3; 340/538; 340/310.11

(57) ABSTRACT

Provided is an apparatus for adjusting the phase difference between different phases in a power line communication (PLC) system. The apparatus includes a power signal blocking unit blocking a power signal and allowing a data signal to pass between two different phases on three-phase power lines; and a data signal delaying unit delaying the data signal by the phase difference between the two different phases. Accordingly, it is possible to prevent data collision and a time delay in data transmission between different phases by employing the phase adjusting apparatus in a PLC system, thereby improving the performance of PLC.

### CROSS-REFERENCE TO RELATED PATENT APPLICATIONS

This application claims the priority of Korean Patent Application No. 2005-125451, filed on Dec. 19, 2005, in the Korean Intellectual Property Office, the disclosure of which is incorporated herein in its entirety by reference.

### BACKGROUND OF THE INVENTION

1. Field of the Invention

The present invention relates to data transmission, and more particularly, to an apparatus for adjusting the phase difference between different phases in a power line communication (PLC) system.

2. Description of the Related Art

Different phases are out of phase by 120 degrees in a power line communication (PLC) system that uses three phases and four power lines. Thus, when data is transmitted between the same phases, the data may collide with data transmitted from a different phase, and when data is transmitted between different phases, a time delay that delays transmission of the data until a next period may occur.

### SUMMARY OF THE INVENTION

The present invention provides an apparatus for adjusting the phase difference between different phases in a power line communication (PLC) system that uses three phases and four power lines, thereby preventing data collision and a time delay in the different phases.

According to an aspect of the present invention, there is provided A phase adjusting apparatus for use in a power line communication system, comprising a power signal blocking unit blocking a power signal and allowing a data signal to pass between two different phases on three-phase power lines, and a data signal delaying unit delaying the data signal by the phase difference between the two different phases.

The frequency of the data signal may be higher than a frequency of the power signal. The power signal blocking unit may comprise a capacitor which has frequency characteristics that block the power signal of low frequency but allow the data signal of high frequency to pass through it.

The data signal delaying unit may comprise a first signal transmission unit delaying a data signal transmitted from a phase A, which is one of the two different phases, by the phase difference between the phase A and the other phase B, and transmitting the delayed data signal to the phase B; and a second signal transmission unit delaying a data signal transmitted from the phase B by the phase difference between the phases B and A, and transmitting the delayed data signal to the phase A.

The first signal transmission unit may comprise an isolator blocking the data signal transmitted from the phase B; and a phase delayer delaying the data signal transmitted from the phase A by the phase difference between the phases A and B.

The phase delayer preferably delays the data signal for a fixed amount of time at all of frequencies available. The phase delayer more preferably includes a Bessel type filter.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a diagram of a power line communication (PLC) system that uses three phases and four power lines;

FIG. 2 is a circuit diagram of an equivalent circuit of the PLC system illustrated in FIG. 1;

FIG. 3 is a diagram illustrating a connection between phases T and S for PLC;

FIG. 4 is a diagram illustrating a connection between the phases T and S illustrated in FIG. 3 via a capacitor;

FIG. 5 is a waveform diagram of signals used for PLC;

FIG. 6 is a diagram illustrating communications established between PLC apparatuses on the same phases in the system illustrated in FIG. 4;

FIG. 7 is a diagram illustrating communications established between PLC apparatuses on different phases in the system illustrated in FIG. 4;

FIG. 8 is a block diagram of a phase adjusting apparatus according to an embodiment of the present invention;

FIG. 9 is a block diagram of a phase adjusting apparatus according to another embodiment of the present invention;

FIG. 10 is a waveform diagram of data signals exchanged between PLC apparatuses on the same phases in a PLC system employing a phase adjusting apparatus according to an embodiment of the present invention; and

FIG. 11 is a waveform diagram of data signals exchanged between PLC apparatuses on different phases in a PLC system employing a phase adjusting apparatus according to an embodiment of the present invention.

### DETAILED DESCRIPTION OF THE INVENTION

A phase adjusting apparatus for use in a power line communication (PLC) system according to embodiments of the present invention will now be described with reference to the accompanying drawings.

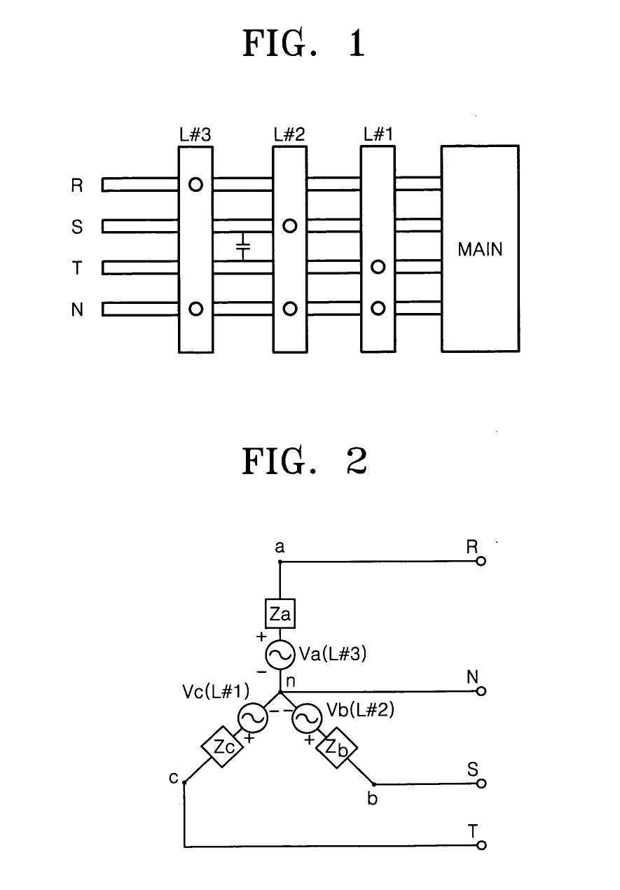

FIG. 1 is a diagram of a PLC system that uses three phases and four power lines. Referring to FIG. 1, the PLC system includes a neural line N, and different three phases R, S, and T that are out of phases by 120 degrees.

In FIG. 1, L#1 connects the load between the phase T and the neural line N, L#2 connects the load between the phase S and the neural line N, and L#3 connects the load between the phase R and the neural line N.

FIG. 2 is a circuit diagram of an equivalent circuit of the PLC system illustrated in FIG. 1. Different three phases R, S, and T are out of phase by 120 degrees. The following equations are satisfied when a maximum voltage of each phase is 220 V:

$$\begin{matrix}{V}_{a} = 220 * sin ( ω t - \frac{4 π}{3} ) & ( 1 ) \\ {V}_{b} = 220 * sin ( ω t - \frac{2 π}{3} ) & ( 2 ) \\ {V}_{c} = 220 * sin ( ω t ) & ( 3 )\end{matrix}$$

From Equations (1) through (3), it is noted that the three phases R, S, and T are out of phase by 2π/3 radian, i.e., by 120 degrees.

ω expressed in Equations (1) through (3) denotes the angular frequency of a power signal, satisfying the following:

w=2πf (4),

wherein f denotes the frequency of a power signal. In general, the power signal has a low frequency from 50 Hz to 60 Hz.

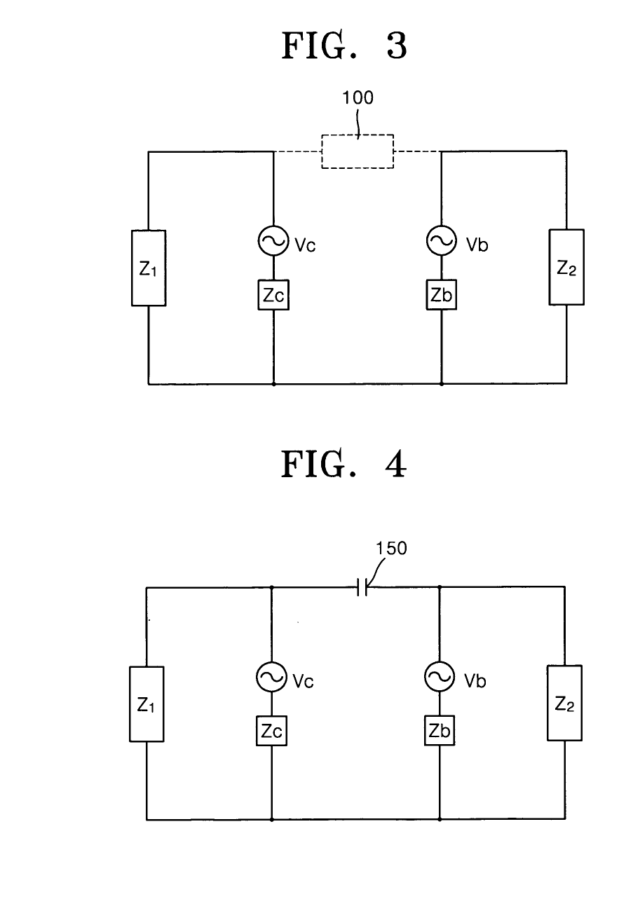

FIG. 3 is a diagram illustrating a connection between phases T and S for PLC. Referring to FIG. 3, the connector 100 that connects the phases T and S is needed to establish communications between a PLC apparatus on the phase T of a voltage Vc and a PLC apparatus on the phase S of a voltage Vb.

FIG. 4 is a diagram illustrating a connection between the phases T and S illustrated in FIG. 3 via a capacitor 150. The capacitor 150 has frequency characteristics that block a low-frequency signal but allow a high-frequency signal to pass through it. The frequency of a data signal used in PLC is preferably higher than that of a power signal.

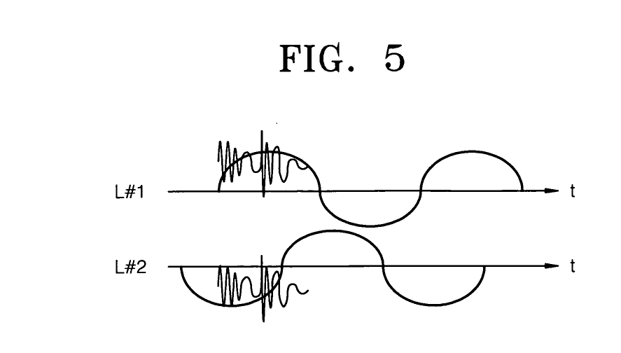

FIG. 5 is a waveform diagram of signals used in PLC. In FIG. 5, a low-frequency signal denotes a power signal and a high-frequency signal denotes a data signal.

It is possible to block the power signal and allow the data signal to pass between the phases T and S by using the capacitor, illustrated in FIG. 4, which has frequency characteristics that blocks the power signal of a low frequency but allows the data signal of a high frequency to pass through it.

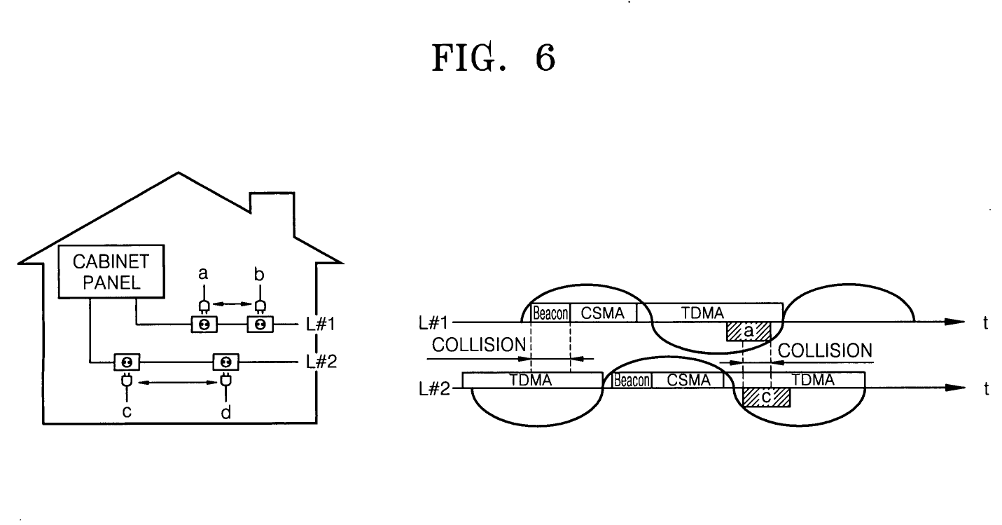

FIG. 6 is a diagram illustrating communications established between PLC apparatuses on the same phases in the system illustrated in FIG. 4. Referring to FIG. 6, communications are established between apparatuses a and b on L#1, and between apparatuses c and d on L#2. In this case, data transmission sections in L#1 and L#2 are out of phase by the phase difference between power signals in L#1 and L#2. Referring to FIG. 6, if data is transmitted from the apparatus a to the apparatus b in a TDMA section in L#1, the data may collide with data transmitted between the apparatuses c and d in a TDMA section in L#2.

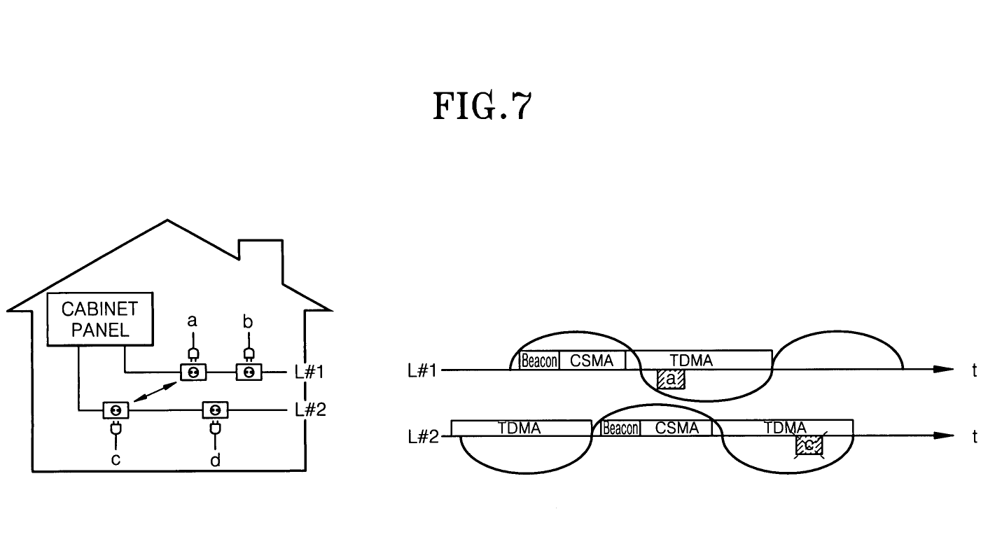

FIG. 7 is a diagram illustrating communications established between PLC apparatuses on different phases in the system illustrated in FIG. 4. In detail, FIG. 7 illustrates data communications established between an apparatus a on L#1 and an apparatus c on L#2.

Referring to FIG. 7, a beacon period for L#1 does not correspond to a beacon period for L#2. To transmit data to the apparatus a in a TDMA section for L#2, the apparatus c determines whether a time slot is assigned to a TDMA section for L#1 and then transmits the data to the apparatus a. If a time slot is not allocated in the same section in which the apparatus c receives data from the apparatus a, the apparatus c cannot transmit data to the apparatus a, and thus transmits the data to the apparatus a in the next TDMA section, thereby causing a time delay.

FIG. 8 is a block diagram of a phase adjusting apparatus 200 according to an embodiment of the present invention. It is possible to prevent data collision or a time delay between different phases by using the phase adjusting apparatus 200 in place of the connector 100 illustrated in FIG. 3.

Referring to FIG. 8, the phase adjusting apparatus 200 may include a power signal blocking unit 210 and a data signal delaying unit 220.

The power signal blocking unit 210 blocks a power signal between different phases but allows a data signal to pass between the different phases. The data signal delaying unit 220 delays transmission of the data signal by the phase difference of power signals between the two phases.

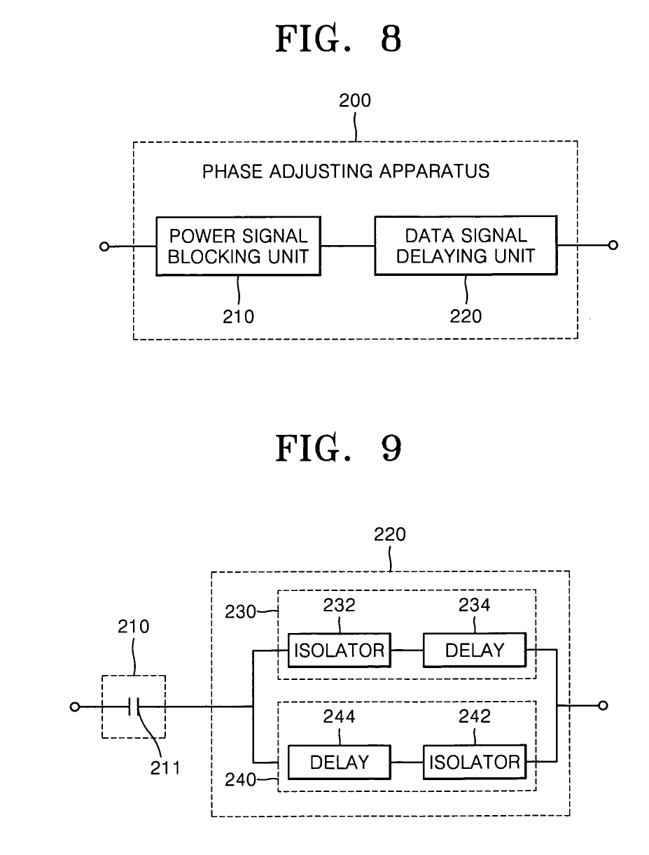

FIG. 9 is a block diagram of another embodiment of the phase adjusting apparatus 200 according to the present invention. In FIG. 9, it is assumed that a power signal blocking unit 210 is connected to a phase A and a data signal delaying unit 220 is connected to a phase B.

The power signal blocking unit 210 may include a capacitor 211 that has frequency characteristics that block a power signal of a low frequency but allow a data signal of a high frequency to pass through it.

The data signal delaying unit 220 may include a first signal transmission unit 230 and a second signal transmission unit 240. The first signal transmission unit 230 delays a data signal received from the phase A by the phase difference between the phases A and B, and transmits the delayed data signal to the phase B. The second signal transmission unit 240 delays a data signal received from the phase B by the phase difference between the phases B and A, and transmits the delayed data signal to the phase A.

The first signal transmission unit 230 may include a first isolator 232 and a first phase delayer 234, and the second signal transmission unit 240 may include a second isolator 242 and a second phase delayer 244. The first and second isolators 232 and 242 respectively block the data signals received from the phases B and A, thereby preventing the data signals from interfering with each other. The first delayer 234 delays the data signal received from the phase A by the phase difference between the phases A and B, and transmits the delayed data signal. The second delayer 244 delays the data signal received from the phase B by the phase difference between the phases B and A, and transmits the delayed data signal. The locations of the first isolator 232 and the first phase delayer 234, and the locations of the second isolator 242 and the second phase delayer 244 may be switched. In this case, the functions, power consumption, or operations of them are not changed.

The delayers 234 and 244 are preferably constructed such that group delays at all of frequencies available are uniform. According to an embodiment of the present invention, the first and second phase delayers 234 and 244 may include a Bessel type filter that delays a data signal for a fixed amount of time at all of frequencies available.

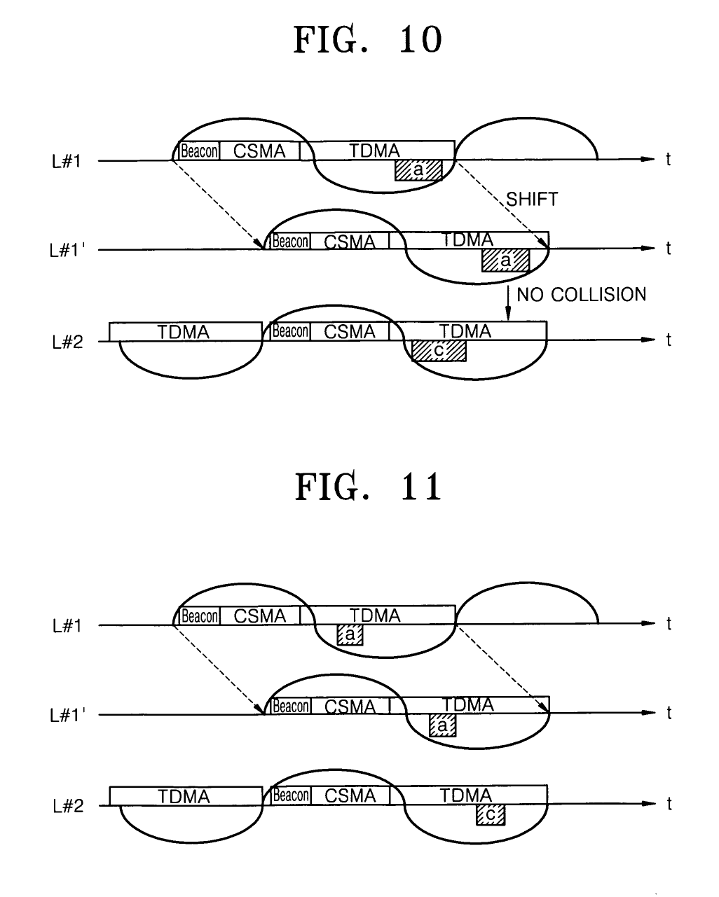

FIG. 10 is a waveform diagram of data signals exchanged between PLC apparatuses on the same phases in a PLC system employing the phase adjusting apparatus 200 according to an embodiment of the present invention. Referring to FIG. 10, a data signal generated in L#1 is delayed by the phase difference between L#1 and L#2 and the delayed signal is transmitted to L#2, thereby preventing collision of data signals.

FIG. 11 is a waveform diagram of data signals exchanged between PLC apparatuses on different phases in a PLC system employing the phase adjusting apparatus 200 according to an embodiment of the present invention. Referring to FIG. 11, a beacon section in L#1 corresponds to a beacon section on L#2. In the beacon section, an agreement regarding assignment of a time slot for a CSMA section and a TDMA section is made between apparatuses. Therefore, since a time slot can be assigned for the TDMA section in the beacon section beforehand, after an apparatus transmits data to an apparatus c, the apparatus c can transmit data to the apparatus a in the same TDMA section in which the apparatus a transmits the data to the apparatus c, thereby preventing a time delay.

It is possible to prevent data collision and a time delay between different phases by employing a phase adjusting apparatus according to the present invention in a PLC system, thereby improving the performance of PLC.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A phase adjusting apparatus for use in a power line communication system, comprising:
a power signal blocking unit blocking a power signal and allowing a data signal to pass between two different phases on three-phase power lines; and
a data signal delaying unit delaying the data signal by the phase difference between the two different phases.

2. The apparatus of claim 1, wherein a frequency of the data signal is higher than a frequency of the power signal.

3. The apparatus of claim 2, wherein the power signal blocking unit comprises a capacitor which has frequency characteristics that block the power signal of low frequency but allow the data signal of high frequency to pass through it.

4. The apparatus of claim 1, wherein the data signal delaying unit comprises:
a first signal transmission unit delaying a data signal transmitted from a phase A, which is one of the two different phases, by the phase difference between the phase A and the other phase B, and transmitting the delayed data signal to the phase B; and
a second signal transmission unit delaying a data signal transmitted from the phase B by the phase difference between the phases B and A, and transmitting the delayed data signal to the phase A.

5. The apparatus of claim 4, wherein the first signal transmission unit comprises:
an isolator blocking the data signal transmitted from the phase B; and
a phase delayer delaying the data signal transmitted from the phase A by the phase difference between the phases A and B.

6. The apparatus of claim 5, wherein the phase delayer delays the data signal for a fixed amount of time at all of frequencies available.

7. The apparatus of claim 6, wherein the phase delayer comprises a Bessel type filter.
